(19) United States
(12) Patent Application Publication
(10) Pub. No.: US 2008/0069428 A1
(43) Pub. Date: Mar. 20, 2008

(54) Single mode digital video gauging system having mechanical drawing annotations and method for same

(76) Inventors: Robert Schulkin, Norwood, NJ (US); Eduardo D. Schulkin, Ridgewood, NJ (US)

Correspondence Address: LEN TAYLOR, PATENT ATTORNEY, 261 DAVENPORT STREET, SOMERVILLE, NJ, 08876, US

(21) Appl. No.: 11/508,378

(22) Filed: Aug. 23, 2006

(51) Int. Cl. G06F 19/00; G06K 9/00

(52) U.S. Cl. 382/141; 700/109; 348/92

(57) ABSTRACT

A method for digital video gauging parts comprising obtaining image data of a part to be gauged, identifying at least one of a plurality of features of the image data for inspection, calculating at least one of a plurality of metrics of said at least one of a plurality of features, creating at least one of a plurality of dimension lines and at least one of a plurality of extension lines corresponding to said at least one of a plurality of features, and displaying on a viewing device in mechanical drawing format said at least one of a plurality of dimension lines, said at least one of a plurality of extension lines, and text of said at least one of a plurality of metrics corresponding to said at least one of a plurality of features in combination with said image data.

### BACKGROUND OF THE INVENTION

1. Field of the Invention

This invention relates to a single mode interactive graphical user interface (“GUI”) digital video gauging system that provides measurements and displays said measurements in an easily understood manner to an operator/user of the interactive software system. More particularly a part to be measured is placed in a measuring device that is controlled by the single mode interactive GUI digital video gauging system. The interactive GUI digital video gauging system can derive metrics of the part, can search a metrics database for previously gauged parts, and can display the metrics of the part to an operator/user with mechanical drawing annotations via a graphical user interface.

2. Discussion of Related Art

In a manufacturing environment a widespread need exists for electronic digital measurement and inspection of parts. Machine part gauging and inspection systems have become vital to many complex manufacturing processes, particularly for quality control. For example, during the manufacture of screws that have specific measurement tolerances, machine part gauging and inspection systems can visually measure the screws at various manufacturing stages to insure accurate measurements, rejecting or accepting screws based on presupposed tolerance specifications of the screws.

Video based machine part measurement and inspection systems typically includes an imaging device, such as an electronic camera, and an interactive computer software system that receives data input from the camera and processes and displays that data input to an operator of the system. The typical measurement system, is generally designed to measure only one view of an object and comprises some form of computer display software, for example a computer screen image of the part being measured.

Conventional gauging systems suffer from at least three major problems. First, the majority of conventional gauging systems lack a convenient way for a non-computer savvy operator to gauge a part. Operators of the system must be familiar with the particular nuances and software commands of the gauging system that they are using. Second, the majority of conventional gauging systems display dimensions in tabular format requiring an operator/user of the system to interpret the table by locating the corresponding dimension for a feature of the part that is being measured. However, this manual interpretation is cumbersome and subject to inaccurately assigning dimensions to a feature of the part. This lack of a convenient way of reading dimensions of a part often leads to inaccurate measurements and re-inspection of the part. Third, conventional gauging systems do not have the ability to store metrics of a part into a database and then later allow an operator/user to retrieve metrics by selecting a part from a list of parts associated with metrics that were previously stored in the database. Accordingly, there is a need for better and easier to use digital video gauging system.

### SUMMARY OF THE INVENTION

The present invention generally relates to a single mode interactive GUI digital video gauging system that computes metrics such as but not limited to measurements, angles, and curvatures of parts, searches a metrics database for metrics of previously stored parts allowing an operator/user the option to select metrics of a part already processed, and displays the metrics in an easily understood mechanical drawing format to an operator/user of the interactive GUI digital video gauging system. This beneficial method allows ease of operation of the system by an operator/user with or without computer programming knowledge. An embodiment according to the present invention comprises a single mode of operation whereby metrics of a part to be gauged are dynamically computed, and displaying on a viewing device in mechanical drawing format, the metrics of the part with dimension and extension lines for various features of the part. Another embodiment according to the present invention comprises searching a metrics database for parts that have previously been gauged, displaying a list of parts to an operator/user whereby an operator/user has an option to select a part from the list, and displaying on a viewing device in mechanical drawing format actual metrics of the part with dimension and extension lines indicating features and tolerance comparisons relative to the metrics of the retrieved part.

An object of the present invention is to provide an efficient and easy to understand solution to the problem of the complex operation of computer driven manufactured part measurement systems that require computer programming knowledge by an operator/user of the part measurement system.

Another object of the present invention is a single mode of operation interactive GUI digital video gauging system that can display metrics in English units, metric units, and any other international standard measurements of a part to an operator/user in mechanical drawing format.

Another object of the invention is to provide an operator/user friendly, efficient interactive GUI digital video gauging system by eliminating operator/user computer programming knowledge from the operation of the gauging system that measures parts thereby creating a single mode of operation requiring no computer programming or specialized gauging system knowledge to measure a part.

Yet another object of the invention is to provide part measurements by using a metrics database search and retrieval of objects that have been associated with a previously gauged part, using the retrieved objects to compute and display current part measurements and tolerance conditions, and dynamically computing and displaying measurements of the part currently being gauged in mechanical drawing format on a viewing device.

### BRIEF DESCRIPTION OF THE DRAWINGS

Preferred embodiments of the present invention will be described below in more detail, with reference to the accompanying drawings:

FIG. 1 is a schematic representation of an interactive GUI digital video gauging system according to an embodiment of the present invention;

FIG. 2 is a representation of a GUI of an interactive digital video gauging system according to an embodiment of the present invention;

FIG. 3 is a schematic representation of a metrics database search and retrieval of objects associated with a previously gauged part according to an embodiment of the present invention;

FIG. 4 is a flow chart of a method for gauging parts and displaying the results in mechanical drawing format according to an embodiment of the present invention;

FIG. 5 is a flow chart of a main processing loop of a digital video gauging system according to an embodiment of the present invention;

FIG. 6 is a flow chart of a tool button processing loop of a digital video gauging system according to an embodiment of the present invention;

FIG. 7 is a flow chart of an exemplary mouse click processing loop of a digital video gauging system according to an embodiment of the present invention;

FIG. 8 is a flow chart of an exemplary mouse click processing loop of a digital video gauging system according to an embodiment of the present invention;

FIG. 9 is a flow chart of a dimension and extension line processing loop of a digital video gauging system according to an embodiment of the present invention; and

FIG. 10 is a flow chart of an object location processing loop of a digital video gauging system according to an embodiment of the present invention.

### DETAILED DESCRIPTION

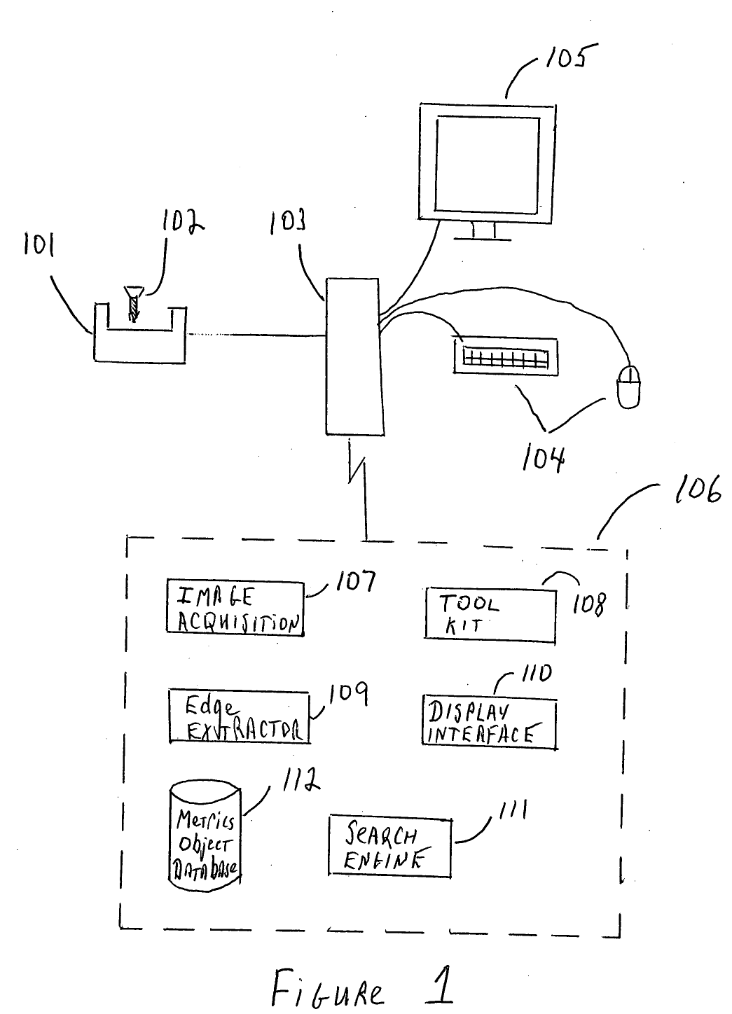

According to an embodiment of the present invention, a single mode of operation digital video gauging system for gauging parts and method for implementing same comprises dynamically computing and displaying metrics of a part in at least one of English units, metric units, and any other international measurement standard in mechanical drawing format to an operator/user of the digital video gauging system. Metrics include but are not limited to tolerances, distance measurements, length measurements, width measurements, height measurements, depth measurements, angular measurements, arc measurements, curvature measurements, circumference measurements, radii measurements, diameter measurements, area measurements, and volume measurements. Another embodiment according to the present invention further comprises searching a metrics database for a corresponding object of a previously gauged part, retrieving the object of the part, using the object to compare tolerances of a part currently being gauged to a part previously gauged, and displaying tolerance comparisons and dynamically computed measurements in mechanical drawing format using a GUI of the digital video gauging system. FIG. 1 is a schematic view of an interactive GUI digital video gauging system according to an embodiment of the present invention.

An image device 101 that can create and process video image data of a part 102 using at least one of a video sensor, a light sensor, a mechanical sensor, an optical sensor, and a laser sensor interacts with a computer 103 having at least one central processing unit (“CPU”). The computer 103 can have input devices 104 such as but not limited to a mouse, a keyboard, and a disk drive, and output devices 105 such as a monitor, a printer, and a disk drive. The part 102 to be measured is evaluated by the image device 101. The image device interacts with various software modules of an interactive GUI digital video gauging system 106 being processed by the computer. An image acquisition module 107 of the interactive GUI digital video gauging system 106 retrieves a video image from the image device 101 and transfers the video image into the computer's memory. A previously created video image data file can also be input into the interactive GUI digital video gauging system 106. The image acquisition module 107 can but does not have to, convert the video image into digital format. A tool kit module 108 comprising a plurality of tools such as a corner tool, a circle tool, an edge tool, and a center tool can be applied to various features of the part 102 such as curvatures, angles, distances, circumferences, diameters, length, height, width, or any other geometric feature that appears on the part 102, and can dynamically compute metrics of the part 102 that is being gauged. Each tool represents a particular metric of the part 102 such as but not limited to curvature measurements, angle measurements, volume measurements, area measurements, or distance measurements. Tools can be added to the tool kit module and existing tools can be modified. At least one of the plurality of tools applies an edge extractor module 109 over predefined features of the video image and uses mathematical functions for example circumference equations, to create an output that is displayed on a output device 105 such as a monitor. The mathematical functions can be standard or non-standard mathematical functions and can vary according to the tool selected. The edge extractor module 109 scans a line within the video image to locate an edge of the feature within the video image. The scanned line can be at any angle. Locating an edge facilitates measurement of a feature and the positioning of dimension lines, extension lines, and measurement text that correspond to the feature being measured. The tool being used can output a measurement and a set of attributes identifying a feature on the video image, such as an edge, corner, or center. The set of attributes can include but are not limited to a name, a feature, an edge location for example a right edge or a left edge, a tool type for example diameter, circumference, length, arc, or angle, and any other data that can be used to identify the feature. A display interface module 110 uses the output from the tool kit module 108 to create extension lines and dimension lines that relate the measurements and set of attributes directly to the video image. The extension lines, the dimension lines, and measurement text are typical to those found in standard mechanical drawings but the extension lines and dimension lines can also be free form. The measurement text can be reverse-highlighted and color-coded to indicate a part's compliance or non-compliance within a tolerance range. The dimension lines can be interactively positioned by an operator/user in conjunction with and onto the video image. Metric readouts can be displayed in a mechanical drawing format onto the video image within a GUI to make viewing the measurement display easily comprehensible. When a tool of the tool kit module 108 outputs a measurement, the tool kit module can also make an entry in a status display panel. The status display panel can be but does not have to be tabular and comprises values such as name, tolerance limits, actual measurements, and an analog indicator that indicates an actual position of the measurement within a tolerance range. The analog indicator can also be but does not have to be color-coded to highlight warning, out of tolerance conditions, and in tolerance conditions. The tool kit module 108 is dynamic and provides a single mode of operation on live video images. The single mode of operation allows an operator/user to select a tool, apply the tool to a feature of the part to be gauged by a dragging and dropping or pointing and clicking method. A preferred embodiment according to the present invention comprises real time computation of all metrics of the part 102. An operator/user does not have to identify and select various features of a part to be measured and then run stored software programs that will compute metrics for the feature of the part being gauged. An embodiment according to the present invention advantageously solves this problem by using a single mode of operation that allows an operator/user to identify and select a feature of the part 102 such as curvature, angle, distance, circumference, diameter, length, height, width, or any other geometric feature that appears on the part, whereby upon feature selection the gauging system automatically and dynamically computes metrics of the feature of the part 102 in a real time environment. A tool of the tool kit module 108 is applied to a video image immediately when selected by an operator/user and measurements are calculated in a real time mode and continuously displayed. Each time a video image changes, for example a new part is placed in the measuring device or a current part is repositioned, metrics are instantaneously recomputed and displayed on a viewing device. Each time a tool is added to the tool kit module 108, or an existing tool of the tool kit module 108 is modified, metrics of the part are immediately recomputed and displayed. This single mode of operation advantageously provides real time measurement data to an operator/user and does not require an operator/user to have any computer programming knowledge to view and measure a plurality of features of the part 102. The interactive GUI digital video gauging system can also use a metrics search engine 111 to search a metrics database 112 for an object such as at least one of a tool, a program, a bit-map, an icon, a sub-routine, a cataloged procedure, data, and any computer programming instruction set of a gauged part, that was previously stored. If an object corresponding to the metrics of the part currently being measured is found in the metrics database, the object can be retrieved and used to compute measurements and tolerances for the current part. In another embodiment according to the present invention the original video image of the part can be stored in the metrics database 112 with a corresponding set of tools representing the metrics of the part being gauged. In another embodiment of the present invention if an object for the manufactured part is not found in the metrics database 112 or if additional manufactured part measurements are desired by an operator/user, the interactive GUI digital video gauging system can dynamically compute additional measurements of the current video image of the part. To compute measurements an operator/user of the system can create and if desired, associate a new object with a part by saving the current object into the metrics database 112. The operator/user requires no computer programming training to create a new object. The computed measurements, sets of attributes, and measurement indicators are used for mechanical drawing annotations and displayed as such on an output device 105 such as a monitor using a GUI of the interactive GUI digital video gauging system 106. In yet another embodiment of the present invention whenever the part 102 to be measured is physically moved relative to the image device 101 new video images are detected by the interactive GUI computer software system 106 which then automatically and dynamically re-computes new measurements of the new view of the video image of the part 102. In another embodiment of the present invention tolerances computed by an object retrieved from the database 112 and additional computed metrics are displayed in mechanical drawing format on an output device 105 such as a monitor using a GUI of the digital video gauging system 106 by using at least one of English units, metric units, and any other international measurement system standard.

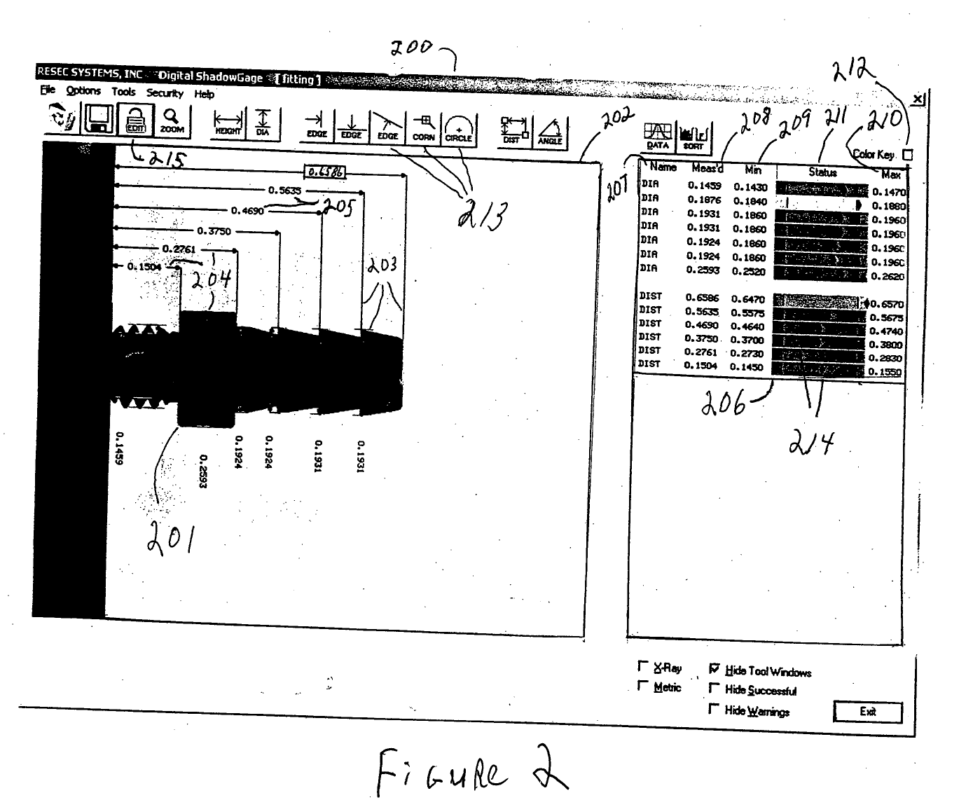

FIG. 2 is an example of a GUI of a digital video gauging system according to an embodiment of the present invention.

A part 201 that is being gauged is displayed in a primary frame 202 on the GUI 200, but other frames can be used. The part 201 is schematically annotated in mechanical drawing format with corresponding measurement indicators. A preferred embodiment according to the present invention displays extension lines 203, dimension lines 204, and dimension text 205. The measurement indicators can also be but are not limited to arrows, directional arrows, length lines, width lines, height lines, corner lines, edge lines, angle lines, arc lines, depth lines and any other measurement indicators such as are typically used by a draftsperson when representing measurements. Each measurement indicator has a corresponding measurement value for example the dimension text 205. The measurement value can be represented in any international measurement standard such as English units and metric units. Adjacent to the manufactured part frame is a chart 206 in tabular form. Charts in other formats can also be used. According to an embodiment of the present invention, the chart comprises various data columns relating to the part, such as part name 207, measurements 208, minimum tolerances 209, maximum tolerances 210, and status 211. In another embodiment according to the present invention additional data columns can be added or deleted from the chart so as to customize the chart for any part being gauged. The status column can be an analog indicator 214 and color-coded to denote whether the measurements of the part are within acceptable tolerances. The status column can also be a digital indicator. Any color scheme can be chosen but in a preferred embodiment according to the present invention dark blue is used to indicate that a dimension of the part is not good since the dimension is under a tolerance range for that part. Light blue is used as a warning to indicate that a dimension of the part is good but on the low end of a tolerance range for that part. Green is used to indicate that a dimension of the part is good and is within acceptable tolerance values of the tolerance range for that part. Pink is used as a warning to indicate that a dimension of the part is good but on the high end of a tolerance range for that part. Red is used to indicate that a dimension of the part is not good since the dimension is over a tolerance range for that part. Yellow is used to indicate that an unresolved condition exists. An unresolved condition can be but is not limited to no data being found for a part, a part is not present to be measured, a selected tool does not correspond to a feature of the part for example a circle is selected for a corner measurement. In another embodiment of the present invention the status column does not have to be color-coded. A check box 212 can be provided that can activate color-coding and denotes whether color-coding is activated or not. Other color-coded indicators can also be used. Various functional push buttons 213 can be positioned on the GUI 200. Activating any of the functional push buttons 213 that correspond to tools provides additional and more detailed measurement data to an operator/user of the interactive GUI digital video gauging system. Objects that are used to compute measurements displayed on the GUI can be saved in a metrics database for future use by depressing a save button 215. When the save button 215 is activated, current metrics objects are stored into a metrics database.

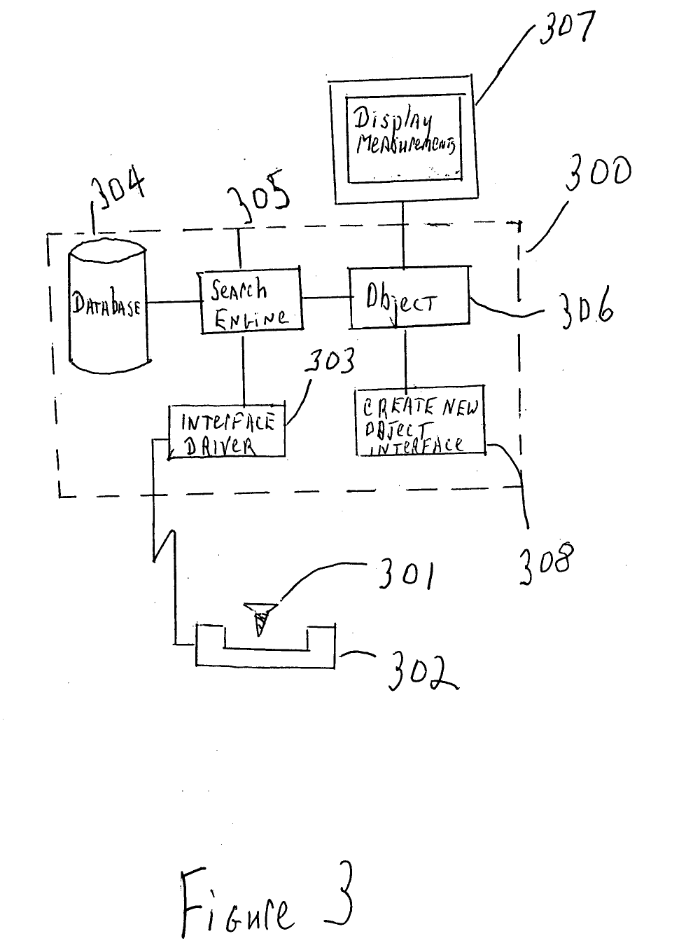

FIG. 3 is a schematic representation of a metrics database search and retrieval process according to an embodiment of the present invention.

A metrics database 304 comprising objects such as at least one of a program, a bit-map, an icon, a sub-routine, a cataloged procedure, data, and any computer programming instruction set, that can compute measurements of various parts is created within the interactive GUI digital video gauging system 300. A part 301 is placed in proximity to or within an image device 302 that is being controlled by an interface driver module 303 of the interactive GUI digital video gauging system 300. The interactive GUI digital video gauging system 300 performs a metrics database search using a metrics search engine 305 to determine if any object 306 exists in the database 304 for the part 301 currently being evaluated. The interactive GUI digital video gauging system searches a metrics database 304 of previously measured parts for a stored metrics object 306. The metrics of the stored object are expanded and applied to related features of the current part 301. To maximize search flexibility and efficiency, the metrics of the current part have to fall within a range of values that is determined by adjusting the values of the stored metrics for each feature with a variable plus or minus factor. For an object 306 to be considered a match, the metrics of the current part 301 must fall within the range of values for each feature stored in the object 306. The retrieved object 306 is used to compute measurements and tolerances for the part 301 currently being evaluated, and the measurements and corresponding part measurement indicators are displayed in mechanical drawing format on a viewing device such as a monitor 307 using a GUI as described above with reference to FIG. 2. If a user desires to update an object or create a new object for a particular part 301, the user may activate an object interface module 308 that saves the current object as was described above in reference to FIG. 2. The object 306 is then replaced or added to the database 304.

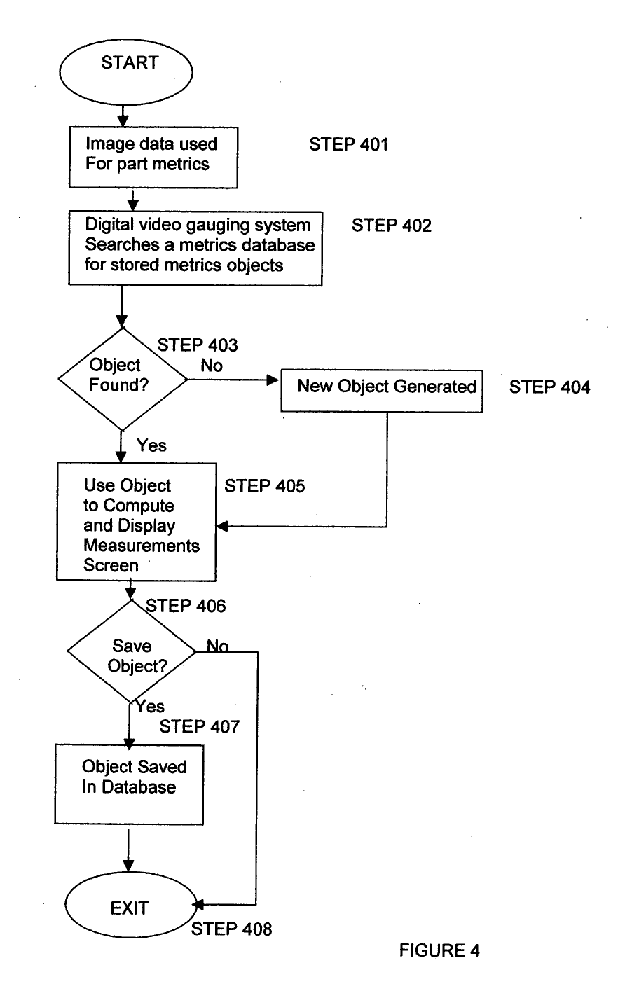

FIG. 4 illustrates a block diagram of a method for gauging parts according to an embodiment of the present invention.

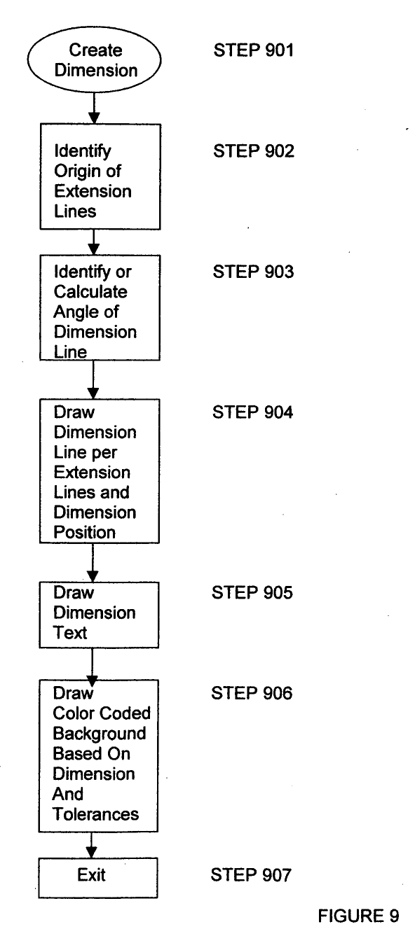

Image data of a part being measured is used by a GUI digital video gauging system to generate metrics for the part (Step 401). The interactive GUI digital video gauging system searches a metrics database of previously measured parts for a stored metrics object (Step 402). The metrics of the stored object are expanded and applied to features of the current part. To maximize search flexibility and efficiency, the metrics of the current part have to fall within a range of values that is determined by adjusting the values of the stored metrics with a variable plus or minus factor. For an object to be considered a match, the metrics of the current part must fall within the range of values for each feature stored in the object. If a single object is found it is automatically expanded and applied to dynamically compute measurements and tolerances for the current part being evaluated. If multiple metrics objects are found (Step 403) a list of parts corresponding to the found metrics objects is displayed to an operator/user. The operator/user has an option to select a part from the list. If an object is not found a new object is generated (Step 404). If an operator/user selects a part from the list the metrics objects associated with the part selected are expanded and applied to dynamically compute measurements and tolerances for features of the current part being evaluated (Step 405). The measurements are displayed with corresponding measurement indicators such as dimension lines, extension lines, and measurement text in mechanical drawing format on a GUI of the interactive digital video gauging system (Step 405). The measurements can be displayed using any international measurement system standard, such as English units and metric units. Any measurements of the part that were not computed by the object retrieved from the metrics database or if an object for the part is not found in the metrics database, are dynamically computed by the interactive GUI computer software system under the direction of an operator/user by using a tool from a tool kit. The operator/user requires no computer programming knowledge to create a new object and requires no computer programming knowledge to edit any object retrieved from the metrics database. The operator/user points and clicks or drags and drops on various measurement indicators and tools positioning those indicators and tools over features of a part. This results in the interactive GUI digital video gauging system computing and displaying the desired measurements and tolerances in mechanical drawing format. In a preferred embodiment according to the present invention tolerances can also be displayed in tabular format having an analog indicator as described below in reference to FIG. 9. When the operator/user is satisfied with the metrics of the part, the operator/user can decide (Step 406) whether to save the current metrics object to the metrics database (Step 407) however the current metrics object does not have to be saved (Step 408).

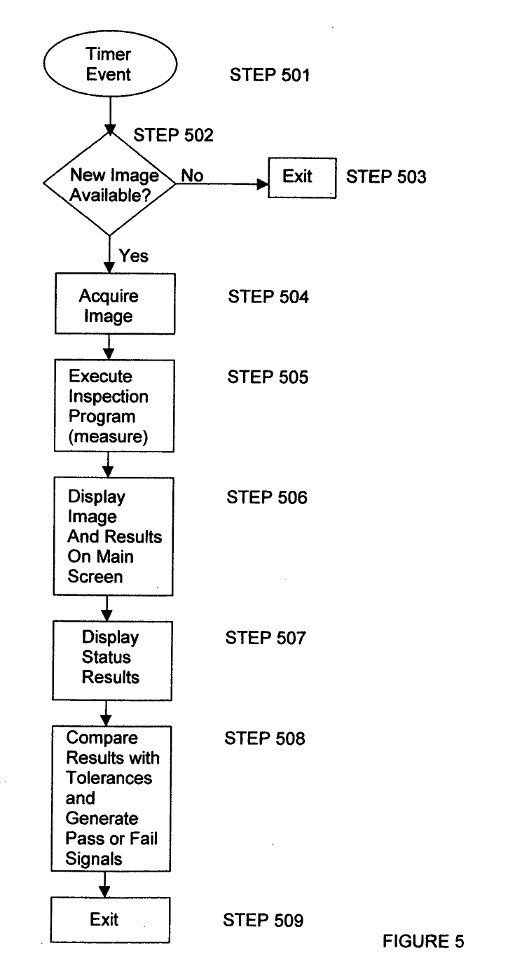

FIG. 5 is a flow chart of main loop processing of a interactive GUI digital video gauging system according to an embodiment of the present invention. An event (Step 501) is triggered at various time intervals to determine if a new image has been made available from an image input device such as a digital camera or a digital recorder as well as data input files but other digital input devices may be used. The time intervals of the event can be fixed or random but the time intervals are generally low so that real time computation processing can be achieved. If a new image is not available (Step 502) loop processing ends (Step 503) otherwise the new image is acquired (Step 504). An inspection program is executed (Step 505) to measure a part that has generated the new image. Results from the inspection program are displayed (Step 506) on a GUI screen in mechanical drawing format. Tolerance status results are displayed (Step 507). A preferred embodiment according to the present invention displays the tolerance status results in color-coded tabular format. Results from the inspection program are compared with stored or operator entered part tolerances. Pass signals or fail signals are generated depending on the comparison results (Step 508). The pass signals or fail signals can be used to change tolerance status colors and to modify a position of an analog tolerance indicator. Loop processing terminates (Step 509).

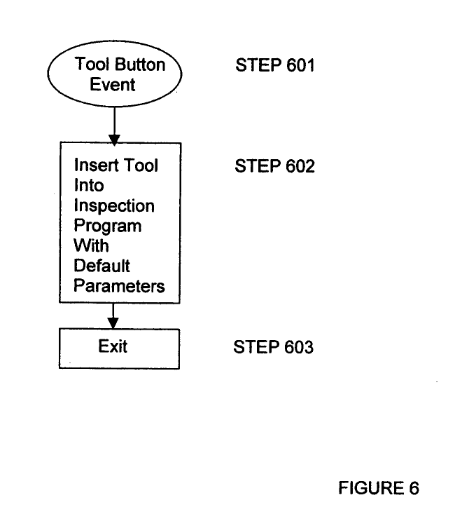

FIG. 6 is a flow chart of a tool button processing loop of an interactive GUI digital video gauging system according to an embodiment of the present invention. An event (Step 601) is triggered to determine which virtual tool will be displayed on the GUI screen. Virtual tools correspond to various metrics of a part and can be but are not limited to tolerances, diameters, height, arcs, width, radii, and other measurements that can be applied to a feature. Once a virtual tool is selected the virtual tool is inserted into an inspection program with default parameters such as height and width values (Step 602). The tool button event loop processing is then exited (Step 603).

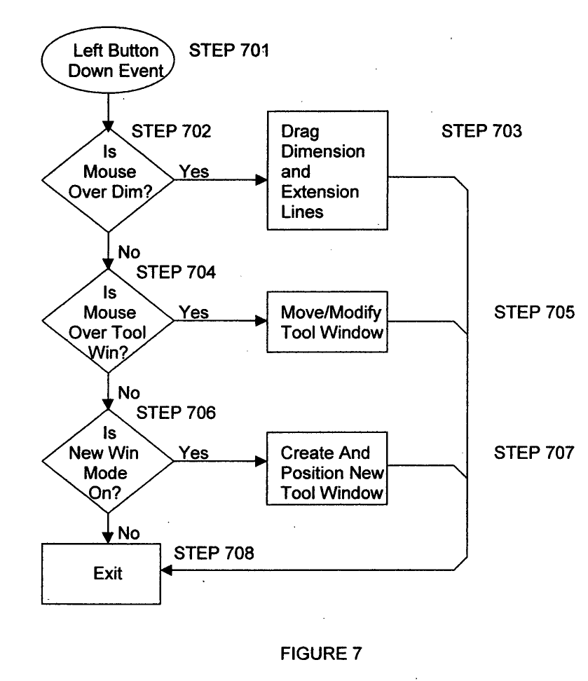

FIG. 7 is an exemplary flow chart of a mouse button down processing loop of an interactive GUI digital video gauging software system according to an embodiment of the present invention.

An event (Step 701) is triggered when a computer mouse button is activated. A preferred embodiment according to the present invention assigns the left mouse button to this event however any mouse button can be assigned. If the computer mouse GUI screen pointer is positioned over a dimension an operator/user (Step 702) can drag dimension and extension lines to a feature of a part that is being measured (Step 703). If the computer mouse GUI screen pointer is positioned over a window corresponding to a tool (Step 704) an operator/user can move or modify the tool window (Step 705). If the position of the computer mouse GUI screen pointer is not positioned over a dimension or a tool window (Step 704) then processing determines if a new window mode is set to “on” (Step 706). If the new window mode is “on” then a new tool window is created and positioned (Step 707) otherwise the left mouse button down processing loop is exited (Step 708).

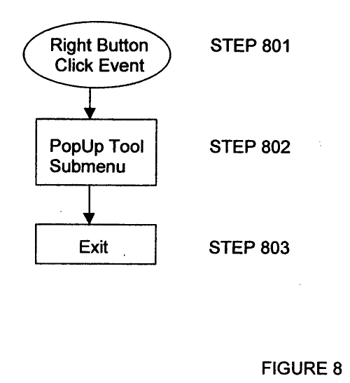

FIG. 8 is an exemplary flow chart of a mouse button down processing loop of an interactive GUI digital video gauging system according to an embodiment of the present invention.

An event (Step 801) is triggered when a computer mouse button is activated. A preferred embodiment according to the present invention assigns the right mouse button to this event however any mouse button can be assigned. A pop up submenu corresponding to a tool is displayed that allows an operator/user to set tool properties (Step 802). Tool properties can be but are not limited to tolerances, vertical measurements, horizontal measurements, white to black edge measurements, circle measurements, diameter, radii, and corners. The right button down processing loop is then exited (Step 803).

FIG. 9 is a flow chart of a dimension line and extension line mechanical drawing processing loop of an interactive GUI digital video gauging system according to an embodiment of the present invention. A dimension is created (Step 901). Each extension line origin can be identified by an edge or corner location (Step 902). Once the origin of each extension line is identified the extension line is positioned by the origin. An angle of the dimension line that will be displayed with the extension line must be calculated (Step 903) to determine whether the dimension line should be displayed vertically, horizontally, or at some angle. The dimension line is drawn in mechanical drawing format being positioned relative to the dimension line's corresponding extension lines (Step 904). Dimensions are calculated and dimension text is then drawn (Step 905). The calculated dimensions are compared to measurement tolerances that have either been retrieved from a metrics database or entered by an operator/user. Dimensions that are displayed in tabular format can be color-coded indicating whether or not those dimensions are within acceptable measurement tolerances for the part that is being measured (Step 906). In a preferred embodiment according to the present invention an analog indicator is used to display current dimension status of the part within a tolerance range. A digital indicator can also be used. The analog indicator can also be color-coded. Any color scheme can be chosen but in a preferred embodiment according to the present invention dark blue is used to indicate that a dimension of the part is not good since the dimension is under a tolerance range for that part. Light blue is used as a warning to indicate that a dimension of the part is good but on the low end of a tolerance range for that part. Green is used to indicate that a dimension of the part is good and is within acceptable tolerance values of the tolerance range for that part. Pink is used as a warning to indicate that a dimension of the part is good but on the high end of a tolerance range for that part. Red is used to indicate that a dimension of the part is not good since the dimension is over a tolerance range for that part. Yellow is used to indicate that an unresolved condition exists. An unresolved condition can be but is not limited to no data being found for a part, a part is not present to be measured, a selected tool does not correspond to a feature of the part for example a circle is selected for a corner measurement. After color coding a background, dimension line and extension line processing loop is exited (Step 907).

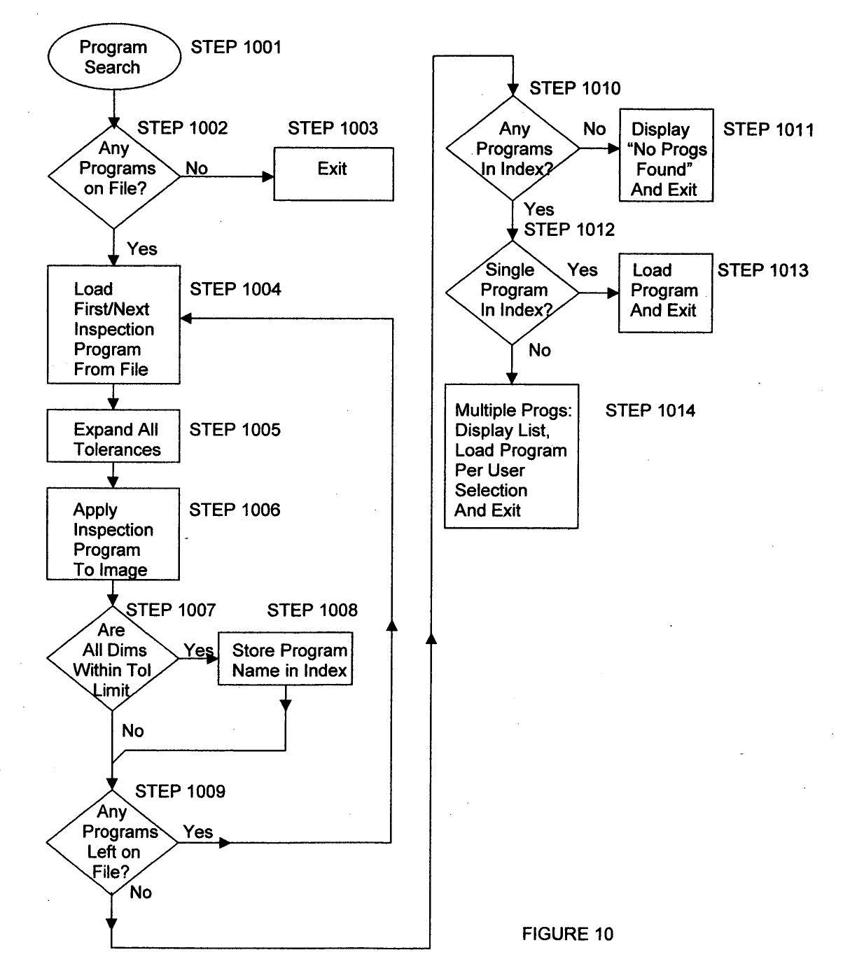

FIG. 10 is a flow chart of an automatic inspection program search procedure of an interactive GUI digital video gauging system according to an embodiment of the present invention.

A metrics database is searched (Step 1001) to determine if any object is available within the metrics database, such as a program that comprises metrics. (Step 1002). If there is no object found the program search procedure is exited (Step 1003). If one or more objects are found within the metrics database then each object is retrieved from the metrics database (Step 1004). Once retrieved all metrics are expanded (Step 1005). To determine if an object corresponds to the image of the part being gauged an inspection program is applied to an image of the part (Step 1006). The object's metrics and tolerances are expanded and applied to various features of the current part to determine if the object is a match (Step 1007). All of the metrics for each stored object are adjusted by using a plus or minus factor to create ranges of values. If the current part has every feature that is in the stored object and falls within the range of values, the object name is stored in an index (Step 1008) otherwise processing continues to determine if more objects are left in the metrics database (Step 1009). If there are more objects in the metrics database then the next object is loaded from the metrics database (Step 1004) and processing continues as above. Once all objects have been checked for acceptability, the index is checked to determine if there are any objects in the index (Step 1010). If there are no objects then a message is displayed and processing exits (Step 1011). If there are objects in the index a check is made to determine if the index has a single object (Step 1012). If there is a single object it is loaded and processing is exited (Step 1013) otherwise a list of objects is displayed as a list of associated parts for an operator/user to select from (Step 1014). Once an operator/user has selected a part and thereby its associated object, processing is exited.

Having described embodiments for a software system stored on a programming storage device and a method for gauging parts, it is noted that modifications and variations can be made by persons skilled in the art in light of the above teachings. It is therefore to be understood that changes may be made in the particular embodiments of the invention disclosed which are within the scope and spirit of the invention as defined by the appended claims.

What is claimed is:

1) A method for digital video gauging parts comprising the steps of:
obtaining image data of a part to be gauged;
identifying at least one of a plurality of features of the image data for inspection;
calculating at least one of a plurality of metrics of said at least one of a plurality of features;
creating at least one of a plurality of dimension lines and at least one of a plurality of extension lines corresponding to said at least one of a plurality of features; and
displaying on a viewing device in mechanical drawing format said at least one of a plurality of dimension lines, said at least one of a plurality of extension lines, and text of said at least one of a plurality of metrics corresponding to said at least one of a plurality of features in combination with said image data.

2) The method of claim 1, wherein said at least one of a plurality of features includes at least one of a corner, an edge, a center, a circumference, a circle, an angle, a distance, a length, a width, a height, a radius, a diameter, an arc.

3) The method of claim 1, wherein said at least one of a plurality of metrics includes at least one of English units measurements and metric measurements.

4) The method of claim 1, wherein said step of calculating at least one of a plurality of metrics includes dynamically calculating at least one of a plurality of metrics in real time mode.

5) The method of claim 1, wherein said step of displaying on a viewing device includes dynamically modifying a position of said at least one of a plurality of dimension lines and said at least one of a plurality of extension lines.

6) The method of claim 1, further comprising the step of searching a metrics database for an object corresponding to said image data by applying said at least one of a plurality of metrics of said at least one of a plurality of features of said object to said image data.

7) The method of claim 6, wherein said at least one of a plurality of metrics of said at least one of a plurality of features of said object are adjusted by at least one of a plus and a minus factor.

8) The method of claim 6, wherein said object includes at least one of a tool, a program, a bit-map, an icon, a sub-routine, a cataloged procedure, data of a previously measured part, and a computer programming instruction set of a previously measured part.

9) A program storage device readable by machine, tangibly embodying a program of instructions executable by the machine to perform method steps for gauging parts, the method steps comprising:
obtaining image data of a part to be gauged;
identifying at least one of a plurality of features of the image data for inspection;
calculating at least one of a plurality of metrics of said at least one of a plurality of features;
creating at least one of a plurality of dimension lines and at least one of a plurality of extension lines corresponding to said at least one of a plurality of features; and
displaying on a viewing device in mechanical drawing format said at least one of a plurality of dimension lines, said at least one of a plurality of extension lines, and text of said at least one of a plurality of metrics corresponding to said at least one of a plurality of features in combination with said image data.

10) The program storage device of claim 9, wherein said at least one of a plurality of features includes at least one of a corner, an edge, a center, a circumference, a circle, an angle, a distance, a length, a width, a height, a radius, a diameter, an arc.

11) The program storage device of claim 9, wherein said said at least one of a plurality of metrics includes at least one of English units measurements and metric measurements.

12) The program storage device of claim 9, wherein said step of calculating at least one of a plurality of metrics includes dynamically calculating at least one of a plurality of metrics in real time mode.

13) The program storage device of claim 9, wherein said step of displaying on a viewing device includes dynamically modifying a position of said at least one of a plurality of dimension lines and said at least one of a plurality of extension lines.

14) The program storage device of claim 9, wherein said method steps further comprising the step of searching a metrics database for an object corresponding to said image data by applying said at least one of a plurality of metrics of said at least one of a plurality of features of said object to said image data.

15) The program storage device of claim 14, wherein said at least one of a plurality of metrics of said at least one of a plurality of features of said object are adjusted by at least one of a plus and a minus factor.

16) The program storage device of claim 14, wherein said object includes at least one of a tool, a program, a bit-map, an icon, a sub-routine, a cataloged procedure, data of a previously measured part, and a computer programming instruction set of a previously measured part.

17) A digital video gauging system comprising:
a computer in communication with a imaging device;
a metrics database stored on the computer, the database including at least one of measurement data, attribute data, and stored image data for a part previously gauged; and
at least one program executing on the computer, said at least one program configured to identify new image data received from said imaging device and perform real-time measurement calculations using at least one of said new image data, said measurement data, said attribute data, and said stored image data and displaying results from said measurement calculations as text in combination with said new image data, in mechanical drawing format using at least one of a plurality of dimension lines and at least one of a plurality of extension lines.

18) The digital video gauging system of claim 17, wherein said at least one program includes at least one program configured to search said metrics database for an object corresponding to said new image data by applying at least one of a plurality of metrics of at least one of a plurality of features of said object to said new image data.

19) The digital video gauging system of claim 18, wherein said object includes at least one of a tool, a program, a bit-map, an icon, a sub-routine, a cataloged procedure, data of a previously measured part, and a computer programming instruction set of a previously measured part.

20) The digital video gauging system of claim 18, wherein said at least one program includes at least one program configured to display at least one of a part name, part tolerance range data, actual measurement data, and an analog indicator indicating a position of said actual measurement data within said part tolerance range data.

21) The digital video gauging system of claim 20, wherein said analog indicator can be color-coded to highlight at least one of a warning condition and a out of tolerance condition.
